(19) United States
(12) Patent Application Publication
(10) Pub. No.: US 2003/0231824 A1
(43) Pub. Date: Dec. 18, 2003

(54) Tunable dispersion compensators

(76) Inventor: Jennifer Yang, Cupertino, CA (US)

Correspondence Address: JENNIFER P. YANG, 1018 CRANBERRY DR., CUPERTINO, CA, 95014, US

(21) Appl. No.: 10/170,799

(22) Filed: Jun. 12, 2002

(51) Int. Cl. G02B 6/26

(52) U.S. Cl. 385/27

(57) ABSTRACT

A general design of a group of all-pass optical filters which reduce the dispersion of optical pulses transmitted therethrough is disclosed. These all-pass filters modify the phase of the optical pulses in a frequency dependent way while maintaining a frequency independent amplitude response. The structure of these filters includes an input port, an output port, a beam splitter/combiner, and three wholly reflective mirrors. Embodiments for both fixed and tunable dispersion compensators are disclosed. An optical circuit involving the application of these filters is also disclosed. The optical designs disclosed herein include several key improvements over prior arts. These improvements of all-pass filters enable a lower insertion loss solution and thereby more efficient optical network system.

### BACKGROUND OF THE INVENTION

1. Field of the Invention

The present invention relates generally to the field of optical communication and more particularly to tunable all-pass optical filters used in dense wavelength division multiplexing (DWDM) applications.

2. Background Art

Optical fiber communication has been an active area of development and is crucial to the rapid exchange of vast amounts of information over long distances. In a typical optical communication system, optical pulses associated with different central wavelengths (i.e., different channels) are first combined in a dense wavelength division multiplexing device (DWDM), the combined optical signal is then amplified, passed through an optical fiber cable (hundreds of km), de-multiplexed, and sent to destination detectors. The maximum distance that optical signals can propagate in an optical fiber prior to optical electrical conversion depends critically on the chromatic dispersion (CD) of the optical fiber. Chromatic dispersion occurs when signal components of differing wavelengths travel at different velocities. The CD broadens optical pulses and thereby limits the distance of travel for a given bit rate and a type of fiber cable. A dispersion compensator equalizes the propagation delays among different wavelength components of a signal, thereby increasing the maximum distance that optical pulses can propagate without the loss of information.

There are several types of prior art dispersion compensators. For example, dispersion compensating fibers (DCF) and chirped fiber Bragg gratings. The disadvantages of DCF are lossy (about 5-10 dB) and the large size of the DCF CD devices. Each of the chirped fiber Bragg gratings, on the other hand, can only compensate dispersion for a limited number of channels (typically 4 channels) and are expansive and difficult to fabricate.

There also exist several prior art wave-guide based dispersion compensators. The disadvantages associated with these types of devices are the substantial fiber to wave-guide coupling losses, as well as polarization dependent losses; both are caused mainly by the small ring type of wave-guide resonator structures involved. Recently, Jordan and Madsen disclosed a wave-guide based dispersion compensator (U.S. Pat. No. 6,389,203 B1, issued on May 14, 2002). As illustrated in FIG. 1, this prior art dispersion compensator consists of an input port 11, an output port 13, two wave-guide couplers, two interconnected wave-guide resonators (14-17 and 15-17, respectively), as well as two phase adjusting localized heaters. U.S. Pat. No. 6,389,203 B1 appears to be the most relevant prior art and is therefore incorporated herein by reference as relevant background material.

Due to the disadvantages of these prior art devices, there exists a need for improved dispersion compensators.

### SUMMARY OF THE INVENTION

The present invention discloses three preferred designs of tunable dispersion compensators. These new designs have a common theme and all are based on a Michelson interferometer with the orthogonal output folded back. In accordance with the present invention, there are a beam splitter and three wholly reflective mirrors in each of the three preferred designs. The input light is first split into two beams and directed towards two of the mirrors of the Michelson interferometer. The reflected beams from those two mirrors are recombined and redirected by the splitter towards the third mirror, as well as the output. The reflected beam from the third mirror is further split into two beams. These two beams are then directed toward the two mirrors in the Michelson interferometer. This coupling procedure repeats many times thereby providing the desired optical path lengths for the dispersion compensators. The tuning of these devices is accomplished by changing the positions of two of the three mirrors along their optical paths. In two of the preferred micro-optics based embodiments, a single-fiber collimator is incorporated to reduce the coupling losses of these devices. In another preferred embodiment, an optical circulator is used in conjunction with the dispersion compensator. This preferred arrangement enable the separation of the output from the input.

### BRIEF DESCRIPTION OF THE DRAWINGS

The aforementioned objects and advantages of the present invention, as well as additional objects and advantages thereof, will be more fully understood hereinafter as a result of a detailed description of preferred embodiments when taken in conjunction with the following drawings in which:

FIG. 1 illustrates a prior art wave-guide dispersion compensator based upon a Mach-Zehnder interferometer with two coupled ring-resonators;

FIG. 2 shows a micro-optics based dispersion compensator in accordance with the first embodiment of the invention;

FIG. 3 displays a second micro-optics based dispersion compensator in accordance with the second embodiment of the invention;

FIG. 4 shows a hybrid wave-guide and micro-optics dispersion compensator in accordance with the third embodiment of the invention;

FIG. 5 illustrates an optical circuit consisting of an optical circulator and a dispersion compensator in accordance with another embodiment of the present invention;

### DETAILED DESCRIPTION OF THE INVENTION

The present invention discloses three preferred designs of tunable dispersion compensators. These new designs share a common theme that they all are based on a Michelson interferometer with the orthogonal output folded back to the input.

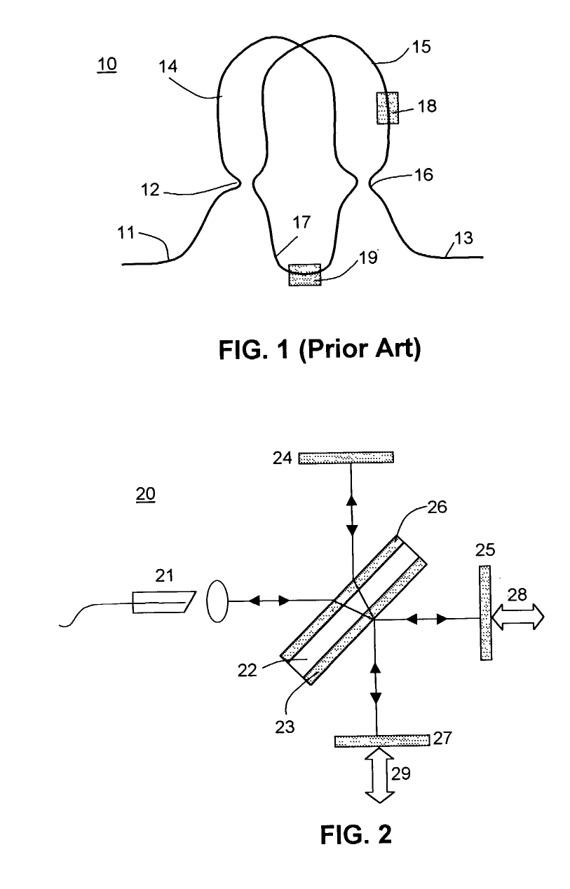

The first preferred embodiment of the present invention is illustrated in FIG. 2. An input is coupled to device 20 through a single fiber collimator 21. The collimated input beam is further split into two beams on a beam splitter 22, oriented at a 45-degree angle with respect to the direction of the input beam. The beam splitter 22 comprises a transparent window with a polarization independent partially reflective coating 23. In one preferred arrangement, a 50% splitting ratio is used. The front surface of the beam splitter is normally covered with an antireflective coating 26. The two split beams propagate towards a first and a second mirror, 24, and 25, respectively. These two mirrors 24, 25 are oriented perpendicularly to the optical path such that the reflected beams will follow identical paths as the incoming beams. The two reflected beams from mirrors 24 and 25 recombine and split once again at the beam splitter. One of the two recombined/split beams moves towards collimator 21, in a path parallel to that of the input beam. The other recombined/split-beam moves towards a third mirror 27, along a path orthogonal with respect to that of the input beam. The third mirror 27 is also oriented perpendicular with respect to the incoming beam such that the reflected beam will follow an identical path as the incoming beam. The reflection from the third mirror travels to the beam splitter 22, and is split into two beams, one beam moves towards the first mirror 24 whereas the other moves towards the second mirror 25. Upon reflection from those mirrors, the aforementioned procedure repeats until the light intensity becomes very small.

In a preferred arrangement, the second and third mirrors, 25 and 27 are attached to two transducers, 28 and 29, respectively, thereby allowing the tuning of mirror positions along the optical paths. Tuning of these mirrors will result in a desired amount of the dispersion compensation from the device.

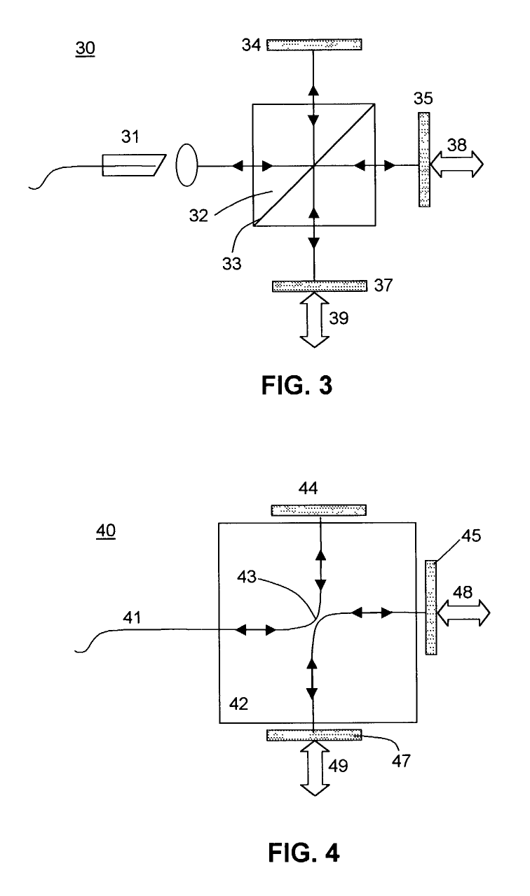

The second preferred embodiment of the present invention is illustrated in FIG. 3. An input is coupled to device 30 through a single fiber collimator 31. The collimated input beam is split into two beams by a cubic beam splitter 32. The beam splitter 32 comprises of two 90-degree prisms with a polarization independent partially reflective coating 33 at the 45-degree interface. In one preferred arrangement, a 50% splitting ratio is used. The outer four surfaces of the beam splitter are normally covered with anti-reflective coatings (not shown). The two split beams propagate towards two mirrors 34, 35, respectively. These two mirrors 34, 35, are oriented perpendicularly to the optical path such that the reflected beams will follow identical paths as the incoming beams. The two reflected beams from mirrors 34 and 35 recombine and split once again on the beam splitter 32. One of the two recombined/split-beams moves towards collimator 31, in a path parallel to that of the input beam. The other recombined/split-beams moves towards the third mirror 37, along a path orthogonal to that of the input beam. The third mirror 37 is also oriented perpendicular with respect to its incoming beam such that the reflected beam will follow an identical path. The reflection from the third mirror travels back to beam splitter 32, and is splitting again into two beams, one moves towards the first mirror 34 whereas the other towards the second mirror 35. Upon reflection from those mirrors, the procedure described previously repeats until the light intensity becomes substantially small.

In yet another preferred arrangement, the second and third mirrors, 35 and 37 are attached to two transducers, 38 and 39, respectively, thereby allowing tuning of their positions along the optical paths. Tuning of these mirror positions will result in a desired amount of the dispersion compensation from the device.

The third preferred embodiment of the present invention is illustrated in FIG. 4. An input signal through an optical fiber 41 is coupled to a wave-guide micro-optics hybrid device 40 through a wave-guide beam splitter 42. The input beam is split into two beams through the wave-guide beam splitter 42. The beam splitter 42 comprises of a polarization independent wave-guide coupler 43. A preferred coupling ratio is 50% transmission, and 50% reflection. The outer four surfaces of the wave-guide substrate are normally covered with anti-reflective coatings and or index matching liquid/epoxy (not shown). The two split beams propagate towards two mirrors 44 and 45, respectively. These two mirrors 44, 45 are oriented perpendicular to the wave-guide such that the reflected beams will follow identical paths as the incoming beams. The two reflected beams from mirrors 44 and 45 recombine and split once again at the beam splitter 43. One of 11 the two recombined/split beams moves towards input fiber 41, in the same waveguide that transmitted the input light. The other recombined/split-beams moves in the wave-guide towards a third mirror 47, along a path orthogonal with respect to that of the input beam. The third mirror 47 is also oriented perpendicular with respect to its incoming beam such that the reflected beam will follow an identical path. The reflection from the third mirror travels back to the beam splitter 43, and is split again into two beams, one moves towards the first mirror 44 whereas the other moves towards the second mirror 45. Upon reflection from those mirrors, the procedure described previously repeats until the light intensity becomes substantially small. In order to reduce coupling losses, the three mirrors are placed at a close distances (few micrometers). Preferably, index matching fluid are used to further reduce coupling losses.

In yet another preferred arrangement, the second and third mirrors, 45 and 47 are attached to two transducers, 48 and 49, respectively, thereby allowing the tuning of their positions along their optical paths. Tuning of these mirror positions will result in a desired amount of the dispersion compensation from the device.

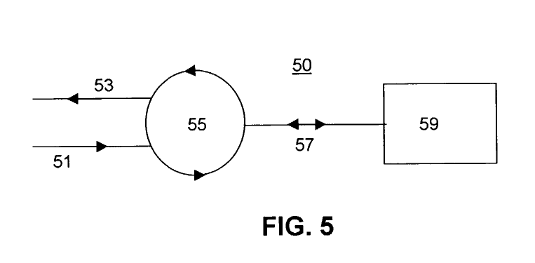

Since the input and output signals share the same optical fiber, a fourth preferred embodiment provides an optical circuit to separate the output from the input. As displayed in FIG. 5, an optical circulator 55 is interconnected to the dispersion compensator 59 which can be one of the previous embodiments, the input signal 51 is separated from the output 53 through the optical circulator.

The physical principle of operation of these dispersion compensators is the following one: The three mirrors forms two coupled optical resonators. For instance, in the device illustrated in FIG. 2, the first mirror 24 and the third mirror forms an optical cavity similar to optical cavities used in a laser system. The free-spectra-range (FSR) is given by FSR1=C/(2(n1eff L1+n3eff L3)), where L1 is the distance from the beam splitter coating 23 to the first mirror, n1eff is the effective index of refraction along the optical path to the first mirror. Likewise, L3 is the distance from the beam splitter coating 23 to the third mirror, n3eff is the effective index of refraction along the optical path to the third mirror.

The second optical cavity is formed through the second mirror 25, the beam splitter coating 23, and the third mirror 27. This optical cavity is also similar to a cavity used in a laser system. The FSR of this second cavity is given similarly by FSR2=C/(2(n2eff L2+n3eff L3)), where L2 is the distance from the beam splitter coating to the second mirror, n2eff is the effective index of refraction along the optical path to the second mirror. Likewise, L3 is the distance from the beam splitter coating 23 to the third mirror 27, n3eff is the effective index of refraction along the optical path to the third mirror.

By properly adjusting the positions of two of the three mirrors, one can adjust the amount of dispersion compensation for a particular channel. If both FSR1 and FSR2 are adjusted substantially close to the channel spacing used in an optical network (for instance 100 GHz or 50 GHz), multi-channel dispersion compensation is realized.

The present invention provides three platforms to make dispersion compensators with predetermined dispersion compensation, as well as dynamic tunable dispersion compensators. In the former case, one adjusts FSR1 and FSR2 for a fixed value of dispersion, then lock all mirror positions. For a tunable device, two of the three mirrors are attached to position transducers such that their positions can be tuned by electrical control signals.

There are many types of transducers and mirror combinations that are suitable for the tunable dispersion compensators. For example, piezo-crystal transducers, electrostatically controlled membrane mirrors, as well as microelectrical-mechanical (MEM) mirrors can all be used to construct tunable dispersion compensators.

It will be apparent to those with ordinary skill of the art that many variations and modifications can be made to these dispersion compensation devices disclosed herein without departing form the spirit and scope of the present invention. It is therefore intended that the present invention covers the modifications and variations of this invention provided that they come within the scope of the appended claims and their equivalents.

I claim:

1. A dispersion compensator comprising:
A shared input and output fiber for receiving the dispersed signal and for the exit of compensated pulses;
A non-polarizing beam splitter/combiner optically coupled to the said input/output fiber;
Three wholly reflective mirrors, each such mirror being optically coupled to the said non-polarizing beam splitter/combiner;
Wherein the three said mirrors and the said input/output fiber being located substantially at the north, south, east and west corners of a square and the said beam splitter/combiner being located substantially close to the center of the said square;
Wherein the said three mirrors having their surface normal parallel to the north-south or west-east directions.

2. The dispersion compensator recited in claim 1 further comprising a single fiber collimator coupling the said input/output fiber with the said beam splitter/combiner.

3. The dispersion compensator recited in claim 2 wherein the said beam splitter/combiner comprising a transparent window with an anti-reflective coated surface and other surface being partially reflective.

4. The dispersion compensator recited in claim 3 wherein at least one of the three mirrors being attached to a position transducer.

5. The dispersion compensator recited in claim 2 wherein the said beam splitter/combiner comprising a cubic beam splitter with a diagonal surface being partially reflective.

6. The dispersion compensator recited in claim 5 wherein at least one of the three mirrors being attached to a position transducer.

7. The dispersion compensator recited in claim 1 wherein the said beam splitter/combiner comprising a wave-guide coupler.

8. The wave-guide coupler recited in claim 7 wherein at least one of the four surfaces having anti-reflective coatings.

9. The dispersion compensator recited in claim 7 wherein at least one of the three mirrors being attached to a position transducer.

10. A method of reducing the dispersion of optical signal comprising the steps of:
Inputting the optical signal into a dispersion compensator through an optical circulator, wherein the dispersion compensator includes a shared input and output fiber, a splitter/combiner, and three wholly reflective mirrors;
Applying a desired phase modification to the optical signal; and
Transmitting the optical signal through the dispersion compensator wherein the amplitude of each frequency component of the optical signal is substantially maintained.

11. The method recited in claim 10 wherein the said dispersion compensator further comprising a single fiber collimator coupling the said input/output fiber with the said beam splitter/combiner.

12. The method recited in claim 11 wherein the said beam splitter/combiner comprising a transparent window with an antireflective coated surface and other surface being partially reflective.

13. The method recited in claim 12 wherein at least one of the three said mirrors being attached to a position transducer.

14. The method recited in claim 11 wherein the said beam splitter/combiner comprising a cubic beam splitter with a diagonal surface being partially reflective.

15. The method recited in claim 14 wherein at least one of the three said mirrors being attached to a position transducer.

16. The method recited in claim 11 wherein the said beam splitter/combiner comprising a wave-guide coupler

17. The method recited in claim 16 wherein at least one of the three said mirrors being attached to a position transducer.
